(19) United States
(12) Patent Application Publication
(10) Pub. No.: US 2013/0090990 A1
(43) Pub. Date: Apr. 11, 2013

(54) Quality Assurance Management

(71) Applicants: Daren Keith Howard, Weston, FL (US); Melanie Denise French, Charlotte, NC (US)

(72) Inventors: Daren Keith Howard, Weston, FL (US); Melanie Denise French, Charlotte, NC (US)

(73) Assignee: BANK OF AMERICA CORPORATION, Charlotte, NC (US)

(21) Appl. No.: 13/267,972

(22) Filed: Oct. 7, 2011

(51) Int. Cl. G06Q 10/00

(52) U.S. Cl. 705/7.41

(57) ABSTRACT

A quality assurance system allows employees to receive performance scores. Data representative of a loan application processed by an employee may be received. Data representative of a first auditor determined loan processing score below an acceptable score may be received. Such data may be based upon the data representative of the loan application processed by the employee. A request initiated from the employee requesting reevaluation of the loan processing score below the acceptable score may be received. A first notice to a manager of the employee may be generated automatically. A response to the generated first notice may be received, the response representative of a determination by the manager to have a second auditor reevaluate the loan processing score. In response, a second notice to the second auditor may be generated automatically, that is representative of the response from the manager to reevaluate the loan processing score.

### BACKGROUND

Efficient quality assurance management is an aspect of many businesses. Efficient quality assurance management includes not only having people with the necessary skill set to perform the work, but also having a manner for correcting mistakes by the individuals performing the work. Often, if a mistake is made in a process by an individual, that same mistake may be made for each and every project on which that the individual works. Until that mistake is addressed with the individual, the same problem may be repeated for some time, each time needing a correction. This may waste time and resources of a business for addressing other projects and may lead to short cuts, etc. that may result in inferior work or delays.

### SUMMARY

In light of the foregoing background, the following presents a simplified summary of the present disclosure in order to provide a basic understanding of some illustrative aspects. This summary is not an extensive overview. It is not intended to identify key or critical elements or to delineate the scope of the illustrative embodiments. The following summary merely presents some concepts of the illustrative embodiments in a simplified form as a prelude to the more detailed description provided below.

Aspects of the present disclosure describe a quality assurance system that delivers real time feedback to employees that creates improved quality and ultimately better customer service. The present disclosure may be utilized in an environment with different quality departments that do not collaborate with each other to ensure an entity has a unified quality standard. Each quality assurance area may be required to analyze the modifications for adherence to compliance and policies. Currently there is no controlled way to manage an employee's workflow. Audits may be performed randomly and inconsistently (hand picking) resulting in lack of control of data. Team leaders do not have a management tool to confirm adherence. Ultimately, more timely data produces improved quality.

A quality assurance system allows employees to receive performance scores. Data representative of a loan application processed by an employee may be received. The data may include records of information obtained by the employee and processes performed by the employee in determining whether to authorize a loan for the loan application. Data representative of a first auditor determined loan processing score below an acceptable score the employee received associated with determining whether to authorize the loan for the loan application may be received. The data representative of the first auditor determined loan processing score may be based upon the received data representative of the loan application processed by the employee. A request initiated from the employee requesting reevaluation of the loan processing score below the acceptable score may be received. A first notice to the manager may be generated automatically. The first notice may be representative of the received request from the employee. A response to the generated first notice may be received. The response may be representative of a determination by a manager of the employee to have a second auditor reevaluate the loan processing score. Then, a second notice to the second auditor may be generated automatically. The second notice to the second auditor may be representative of the received response from the manager to have the second auditor reevaluate the loan processing score.

In accordance with other aspects of the present disclosure, a third notice to the employee including the loan processing score below the acceptable score and at least one reason the employee received the loan processing score may be automatically generated. Still further, a fourth notice to the manager of the employee including the loan processing score below the acceptable score and at least one reason the employee received the loan processing score may be automatically generated. In accordance with other aspects of the present disclosure, data representative that the reevaluation of the loan processing score by the second auditor is complete may be received. Such data may be received from the second auditor.

In accordance with still other aspects of the present disclosure a determination may be made as to whether a time period has lapsed between generation of the second notice to the second auditor and receipt of a response from the second auditor. Upon determining that the time period has not lapsed, data representative that the reevaluation of the loan processing score by the second auditor is complete may be received. Another notice to the employee and the manager may be automatically generated. Such a notice may be representative of a reevaluated loan processing score for the employee.

In accordance with yet another aspect of the present disclosure, a determination may be made as to whether a time period has lapsed between generation of the second notice to the second auditor and receipt of a response from the second auditor. Upon determining that the time period has lapsed, another notice to the employee and the manager may be automatically generated. Such a notice may be representative that the loan processing score will not be reevaluated by the second auditor.

Aspects of the disclosure may be provided in one or more non-transitory computer-readable medium storing computer-executable instructions that, when executed by one or more processors, cause a computer or other apparatus to perform one or more of the operations described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and not limited in the accompanying figures in which like reference numerals indicate similar elements.

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is an illustrative quality assurance system according to one or more aspects of the present disclosure;

FIG. 4 is flowchart of an illustrative method of quality assurance according to one or more aspects of the present disclosure; and

FIGS. 5-10 illustrate example user interfaces for quality assurance systems according to one or more aspects of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

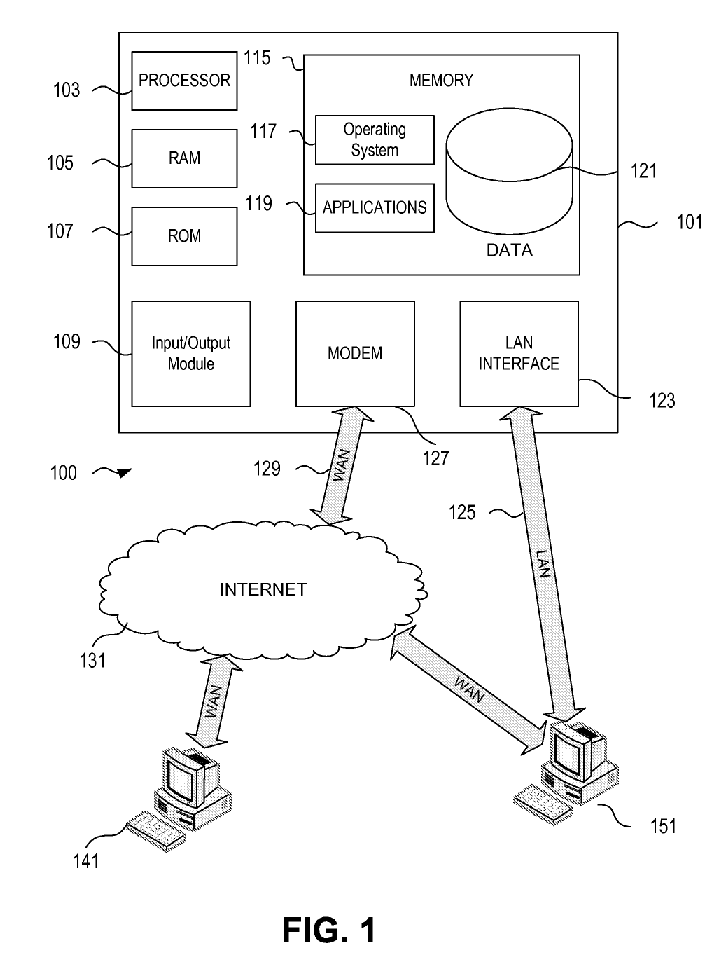

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

I/O 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of account information and account holder information for the entire business, allowing interoperability between different elements of the business residing at different physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the server 101 according to an illustrative embodiment of the disclosure may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

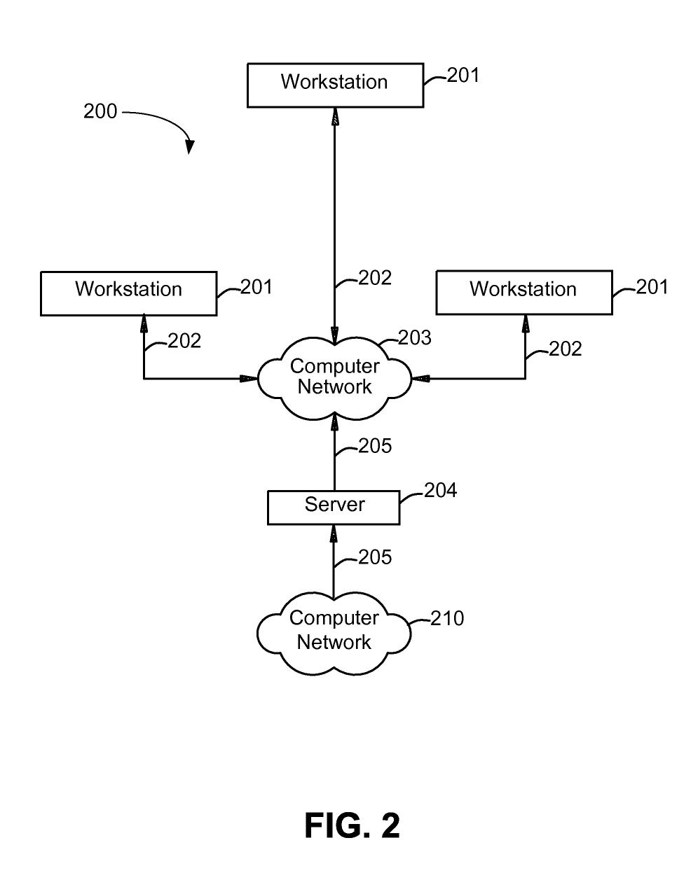

Referring to FIG. 2, an illustrative system 200 for implementing methods according to the present disclosure is shown. As illustrated, system 200 may include one or more workstations 201. Workstations 201 may be local or remote, and are connected by one or communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

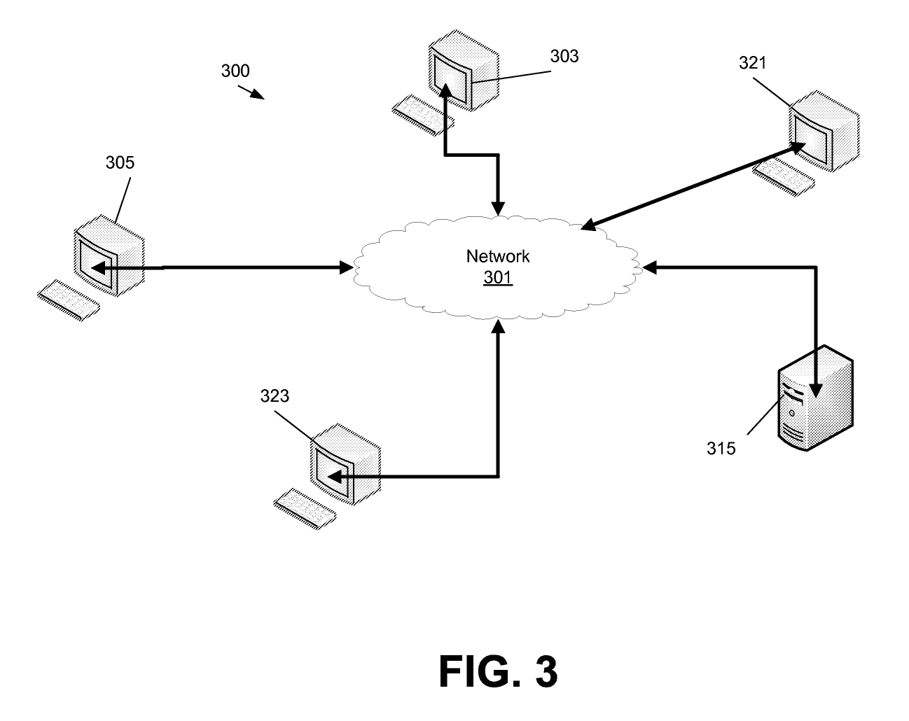

FIG. 3 is an illustrative quality assurance system 300 according to one or more aspects of the present disclosure. Aspects of the quality assurance system 300 as described herein allow for employees to quickly receive feedback on the quality of their work for processing loan applications. In utilizing one or more aspects of the quality assurance systems described herein, such as quality assurance system 300, lapses in time that causes rework, increased defects, increased time, poor customer satisfaction, and the inability to achieve quality goals, may be reduced. Quality assurance system 300 also allows a manager of an employee to compare numerous employees within the entity, and/or on a team. Employees and managers may be informed of employee performance throughout the entire process of a project, such as a loan application, and/or sooner after mistakes are made. Evaluations of work performance for employee are provided in a short period of time, such as 24 hours, in comparison to once a month, one every three months, or once a year. A quality assurance system as described herein allows a manager to see an aggregate of a team score and allows the manager to drill down to individual scores to manage a team more effectively. Still further, such a system may allow for the ability to perform reevaluations for checks and balances on quality.

Quality assurance system 300 may include computing device 315, such as server, which may be figured in accordance with one more aspects described herein. An employee may utilize a computing device 303 in order to process a loan application. Computing device 303 may be a terminal station, as a desk top computer, a laptop computer, and/or some other type of computing device. In processing a loan application, an employee may enter data for various forms affiliated with the evaluation as to whether to grant or deny a loan application. In other instances, an employee may enter and provide data for reasons in offering a certain amount for a loan, e.g., the justification for the amount of the loan. In yet other instances, an employee may have a checklist of items for processing a loan application and the completion of or failure to perform these items may be determined, entered into, and/or verified by computing device 303. Computing device 303 further may be configured to receive notices, such as emails, directed to the employee about her performance with respect to processing one or more loan applications and to send requests or responses, such as in the form of emails, to such notices.

A manager of the employee may utilize a computing device 305 for review of the performance of the employee as well as other individuals, such as other employees that the manager oversees. The manager may utilize computing device 305 in order to review work performance, including determining whether to reevaluate the performance of an employee. Computing device 305 may be a terminal station, as a desk top computer, a laptop computer, and/or some other type of computing device. Computing device 305 further may be configured to receive notices, such as emails, directed to the manager about an employee's performance with respect to processing one or more loan applications and to send requests or responses, such as in the form of emails, to such notices.

An auditor may utilize a computing device 321 for review of the performance of the employee. The auditor may utilize computing device 321 in order to review work performance. The auditor may review records of information obtained by the employee and the processes performed by the employee in determining whether to authorize a loan for a loan application. The auditor may confirm that entity policies, governmental policies, and/or external policies were adhered to in the employee's processing of the loan application. In response, the auditor may assign a loan processing score for a particular loan application processed by the employee. Such a score may be in the range of 0-100. There may be one or more acceptable scores for evaluating an employee's performance. An acceptable score may be a score that determines whether the employee passed or failed in processing the loan application. For example, a failing score may be indicative that the employee performed one or more mistakes that are too problematic to not be corrected. In addition, there may be various levels of scores above a pass/fail score, e.g., 70, that may be indicative of a satisfactory performance, e.g., 80, a good performance, e.g., 90, up to an excellent performance, e.g., 100. Computing device 321 may be a terminal station, as a desk top computer, a laptop computer, and/or some other type of computing device. Computing device 321 further may be configured to receive notices, such as emails, directed to the auditor about an employee's performance with respect to processing one or more loan applications and to send requests or responses, such as in the form of emails, to such notices.

Another auditor may utilize a computing device 323 for reevaluating the performance of an employee. The auditor may utilize computing device 323 in order to reevaluate work performance based upon a request by the employee and the employee's manager to reevaluate a loan processing score. The auditor may review records of information obtained by the employee and the processes performed by the employee in determining whether to authorize a loan for a loan application. The auditor may confirm that entity policies, governmental policies, and/or external policies were adhered to in the employee's processing of the loan application. In response, the auditor may assign a new loan processing score for a particular loan application processed by the employee or may maintain the same score previously assigned to the processing of the loan application by the employee. Although shown as two different auditors and/or computing devices 321 and 323 in FIG. 3, it should be understood that one auditor may perform both operations of a first evaluation for assigning a loan processing score as well as reevaluating the loan processing score in the event of a request to do so. Computing device 323 may be a terminal station, as a desk top computer, a laptop computer, and/or some other type of computing device. Computing device 323 further may be configured to receive notices, such as emails, directed to the auditor about an employee's performance with respect to reevaluating one or more loan processing scores and to send requests or responses, such as in the form of emails, to such notices.

Computing device 315 may be configured to maintain various records of data and other information for each of the respective people included as part of the quality assurance system 300. For example, computing device 315 may maintain email records, loan processing scores, auditor records, employee records, manager records, and/or other data. Computing device 315 further may be configured to maintain of record of how long certain transactions have taken to be completed. For example, computing device 315 may be configured to track how long an employee takes to complete the processing of a loan application, how long since a request for reevaluation of a loan processing score was sent to an auditor, and/or other time periods.

Computing devices 303, 305, 315, 321, and 323 may include one or more network interfaces, which can permit communication with various other computing devices through a network 301. Networks 301 may include, for example, networks of Internet devices, telephone networks, cellular telephone networks, fiber optic networks, local wireless networks (e.g., WiMAX), satellite networks, and any other desired network, and the interface may include the corresponding circuitry needed to communicate on the network 301, and to other devices on the network such as a cellular telephone network and its corresponding cell phones.

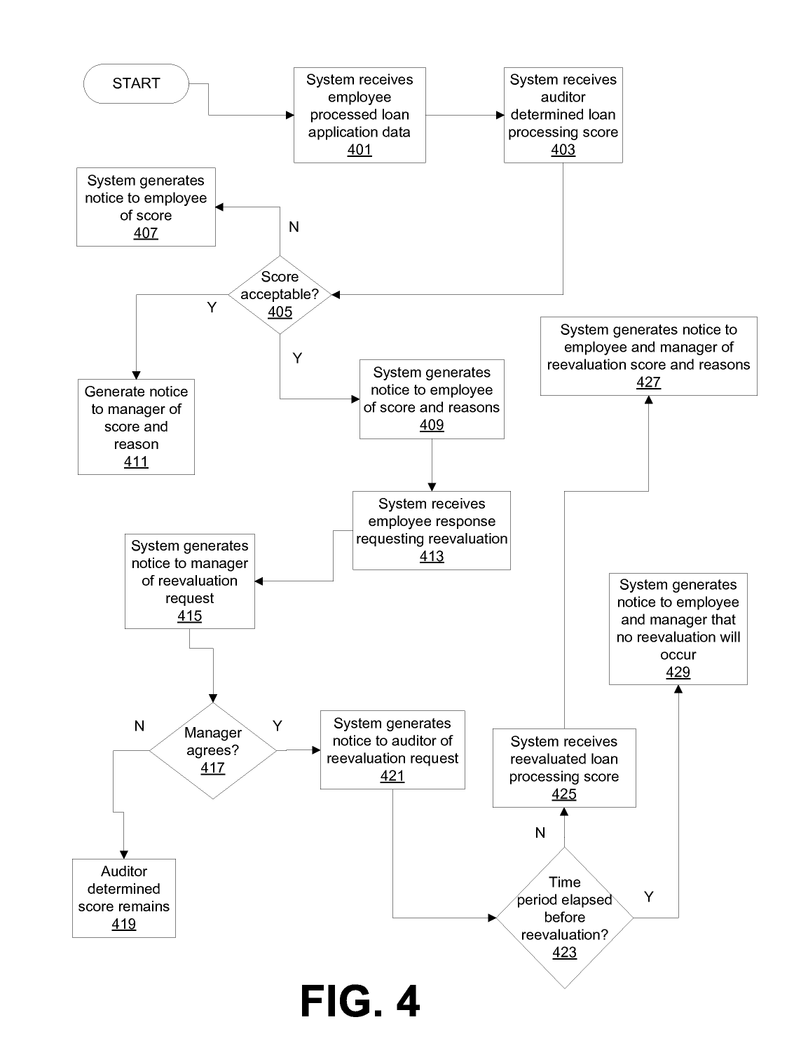

FIG. 4 is flowchart of an illustrative method of quality assurance according to one or more aspects of the present disclosure. One or more aspects of the description of FIG. 4 may be implemented by computing device 315 in FIG. 3. The process starts and at 401, a quality assurance system may receive data representative of a loan application processed by an employee. The data may include records of information obtained by the employee and processes performed by the employee in determining whether to authorize a loan for the loan application. The authorization of the loan may include an amount for the loan. Proceeding to 403, the system may receive data representative of a first auditor determined loan processing score the employee received associated with determining whether to authorize the loan for the loan application. The data representative of the first auditor determined loan processing score may be based upon the received data representative of the loan application processed by the employee. The auditor may have determined the loan processing score for the employee as 60, which is below what may be an illustrative acceptable score for the system of 70. The auditor may have included the reasons for the basis of the score, such as the specific problems attributed to the processing of the loan application by the employee. The auditor may send the loan processing score by loading the score through a computing device, such as computing device 321 in FIG. 3.

In 405, a determination may be made by the system as to whether the loan processing score received in 403 is below an acceptable score. For example, if the auditor determined the loan processing score for the employee as 92, and the acceptable score for the system is 70, the determination from 405 may proceed to 407 where the system may automatically generate a notice to the employee of the loan processing score. In addition, although not shown, a similar notice of the employee's loan processing score may be generated for a manager of the employee as well. Because the loan processing score is or is above an acceptable score, the process may end at 407. In another example, if the auditor determined the loan processing score for the employee as 62, and the acceptable score for the system is 70, the determination from 405 may proceed to 409 and 411 where the system may automatically generate a notice to the employee in 409 of the loan processing score and a notice to the manager in 411 of the employee's loan processing score. The notice to the employee in 409 and/or the manager in 411 may include one or more reasons the employee received the loan processing score.

From 409, an employee may review the loan processing score and the one or more reasons why the score was below an acceptable score and may believe that the score is not accurate for the work performance of the employee. For example, the employee may see that the reason for the score being below an acceptable score was that the employee did not provide certain documentation, such as wage records, to accompany the loan application. Yet, the employee may believe that she did in fact include such documentation and included them with the processing of the loan application. In such a circumstance, proceeding to 413, the system may receive a request initiated from the employee requesting reevaluation of the loan processing score below the acceptable score. This is a check and balance in the system to allow an employee to immediate question the basis for a loan processing score in order to prove a better work performance record for the employee than might otherwise exist. The employee may receive the loan processing score at a computing device, such as computing device 303 in FIG. 3, and/or may send a reevaluation request through such a computing device.

Moving to 415, the system automatically may generate a notice to the manager. The notice may be in the form of an email. The notice may be representative of the received request from the employee asking the manager to look into the issue and/or approve a reevaluation of the loan processing score. In 417, after review by the manager, a determination may be made as to whether the manager agrees with the employee that the employee loan processing score should be reevaluated. If the manager does not agree, the process moves to 419 where the original loan processing score by the auditor remains unchanged. However, if the manager does agree with the employee in 417, the process moves to 421 where the system automatically generates a notice to an auditor. The notice to the auditor may be representative of the received response from the manager to have the second auditor reevaluate the loan processing score. The auditor sent the generated notice may be the same auditor that issued the loan processing score received in 403 or may be a different auditor. The manager may receive the request for reevaluation of the employee loan processing score at a computing device, such as computing device 305 in FIG. 3, and/or may send a reevaluation request through such a computing device.

In 423, a determination may be made as to whether a period of time has elapsed since the notice to the auditor was generated in 421 and reevaluation by the auditor was received by the system. For example, in order to ensure that time delays do not occur in processing of work performance by employees, the system may be configured to allow for an auditor to determine whether to reevaluate the loan processing score of the employee and provide a result of the reevaluation within a specific time period, such as 3 days. As such, in one example, if the 3 day period has elapsed since receiving a reevaluation of the loan processing score from the auditor, the process moves to 429 where the system generates a notice to the employee and the manager. The notice may be representative that the loan processing score will not be reevaluated by the auditor since the 3 day time period has lapsed. If the time period has not lapsed in 423, the process moves to 425 where the system may receive data representative that the reevaluation of the loan processing score by the auditor is complete. This data may include a reevaluated loan processing score. The reevaluated loan processing score may be a different score than the one received in 403 or may be the same score as reevaluated by the auditor. Then, in 427, the system may automatically generate a notice to the employee and manager of the reevaluated loan processing score. The notice may include one or more reasons the employee received the reevaluated loan processing score.

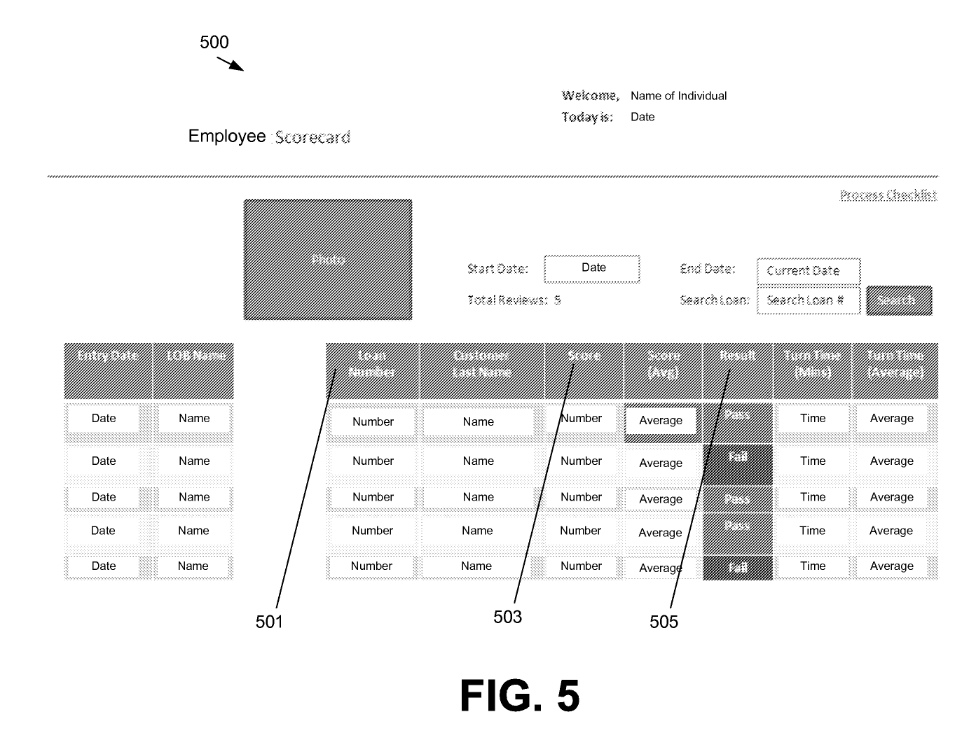

FIGS. 5-10 illustrate example user interfaces for quality assurance systems according to one or more aspects of the present disclosure. FIG. 5 is an illustrative employee scorecard user interface 500 that shows numerous loan processing scores that an employee may have. Loan number column 501 may show some number or code affiliated with a particular loan application that the employee handled. Score column 503 may show a number corresponding to a score the employee received as part of an evaluation by an auditor of a loan application the employee processed. This loan processing score may be an original loan processing score or may be a loan processing score after reevaluation. Although not shown, both an original loan processing score and a reevaluation loan processing score may be shown and/or provided. Result column 505 may be shown to provide a quick reference for the employee to see which loan applications she processed that received passing results and which ones received failing results.

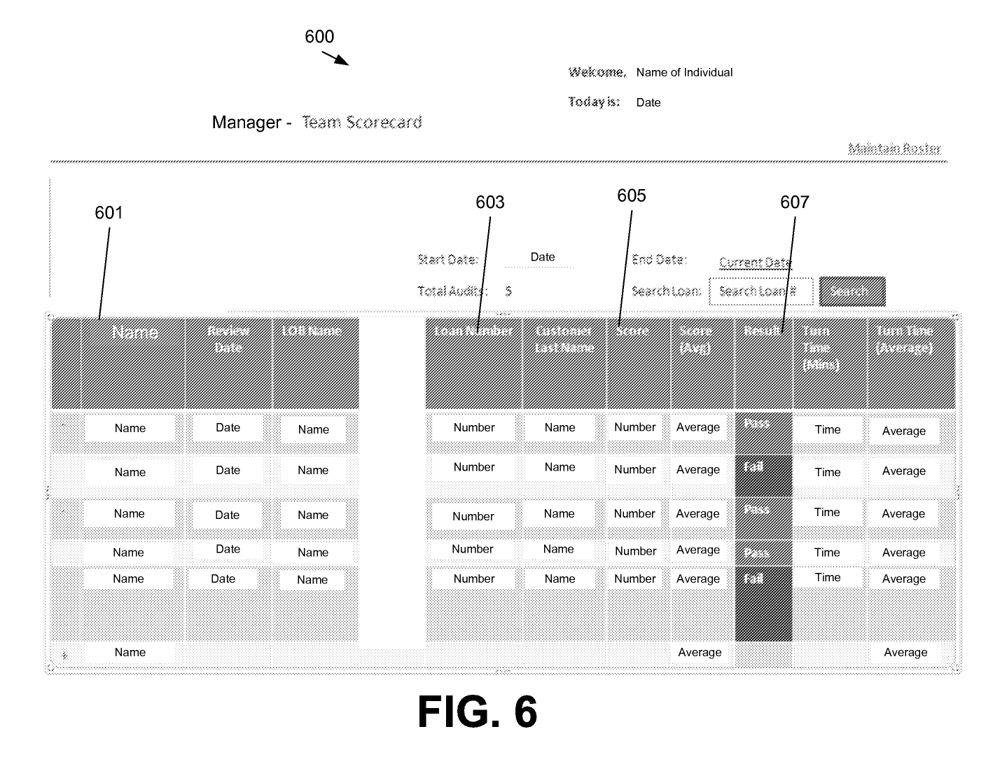

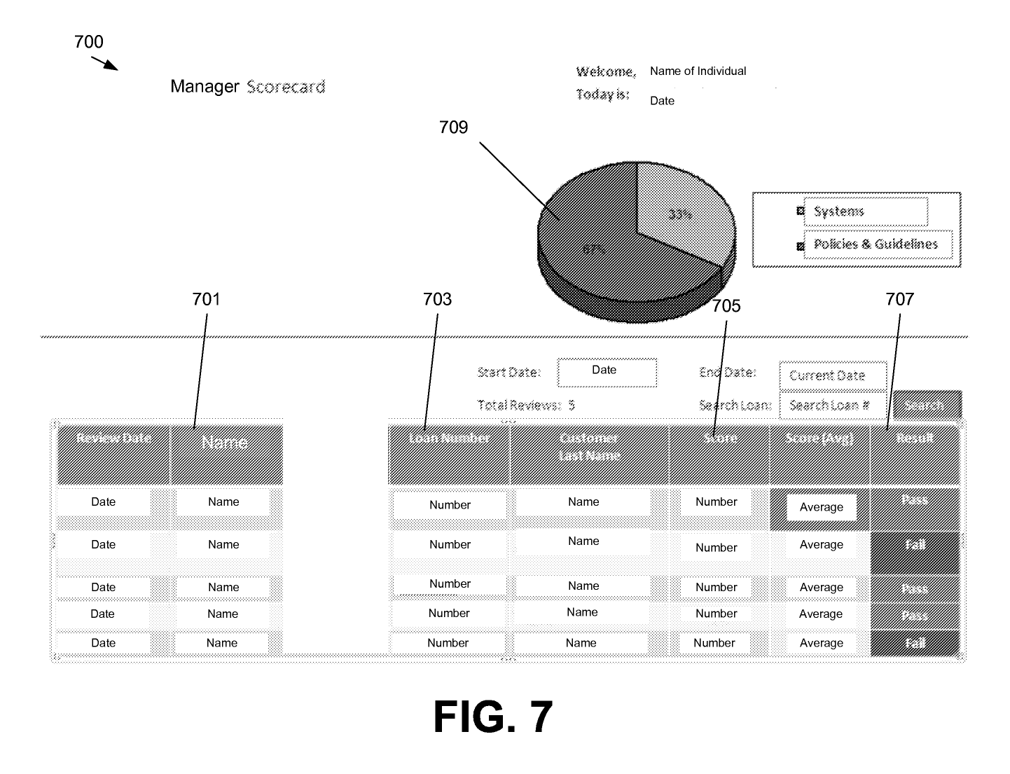

FIGS. 6 and 7 are illustrative manager user interfaces 600 and 700 that show numerous loan processing scores that various employees that the manager may oversee have. In FIG. 6, user interface 600 includes a name column 601 that may be a listing of all employees for a team that the manager oversees. Other data associated with various loan applications may be provided in loan number column 603, score column 605 and results column 607. If additional details are needed, a manager may drill down within a respective entry for more information. For example, in viewing the results column 607, a manager may access a results entry of fail in order to see the details of why the loan application by that employee received a failing score. In such an example, one or more reasons for receipt of and/or calculation of the failing score may be provided to the manager.

FIG. 7 shows a user interface 700 includes a name column 701 that may be a listing of all employees that the manager oversees and has or needs to review. Other data associated with various loan applications may be provided in loan number column 703, score column 705 and results column 707. If additional details are needed, a manager may drill down within a respective entry for more information. In addition, a graphic 709 may be shown for the manager to quickly see the areas in which failure is occurring. For example, in the example user interface 700, graph 709 indicates that 67% of the failures and/or errors made by employees are policies and guidelines related. As such, a manager may quickly determine a need for more training on such a topic.

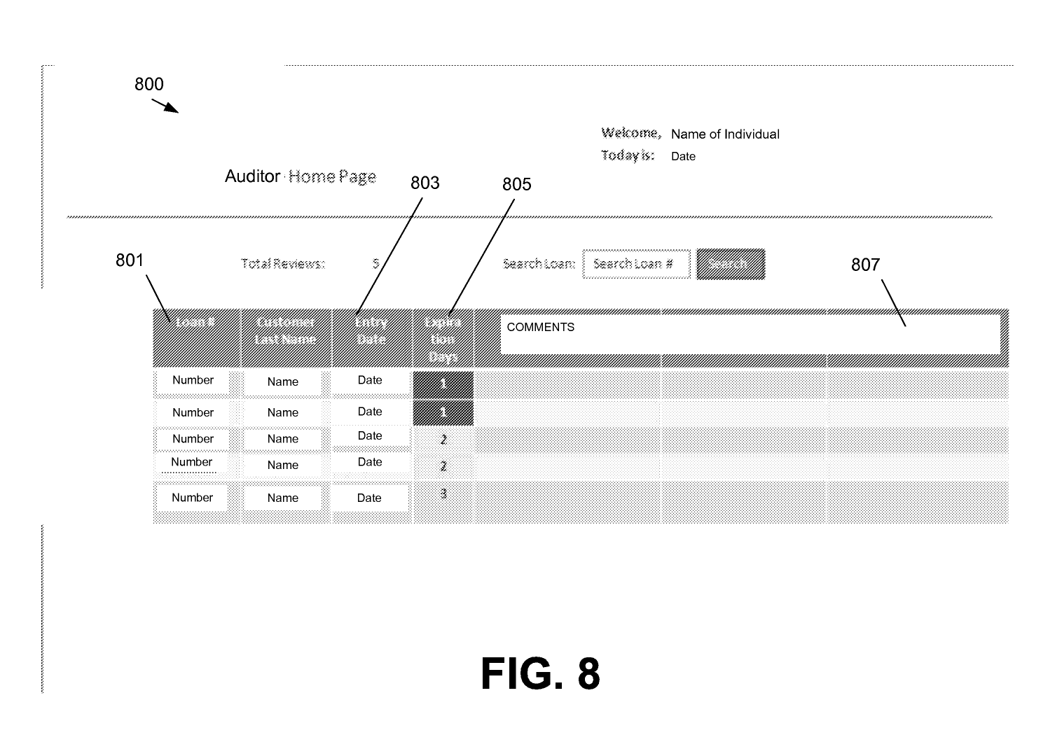

FIG. 8 is an illustrative auditor user interface that shows numerous loan applications needing loan processing scores. Loan number column 801 may show some number or code affiliated with a particular loan application that needs evaluation. Entry date column 803 shows the date in which the loan application for evaluation was received by the auditor. A period of time may be established in which an auditor is required and/or should evaluate an employee's processing of a loan application. Such a period may be 3 days and would be shown in column 805 as the number of days remaining until the time period expires. Comments filed 807 allows the auditor to enter a loan processing score for the loan application and include one or more reasons for the score if so needed.

In another configuration, user interface 800 may be an interface an auditor may see in determining whether to reevaluate a previous loan processing score. Although not shown, a reason for the request to reevaluate may be included and the auditor may reevaluate a previously assigned loan processing score for a loan application. As noted in this example user interface 800, no identification of the employee that processed the loan application is shown. As such, a level of separation between the auditor and the employee in question may remain to ensure a subjective analysis of the processing of the loan application.

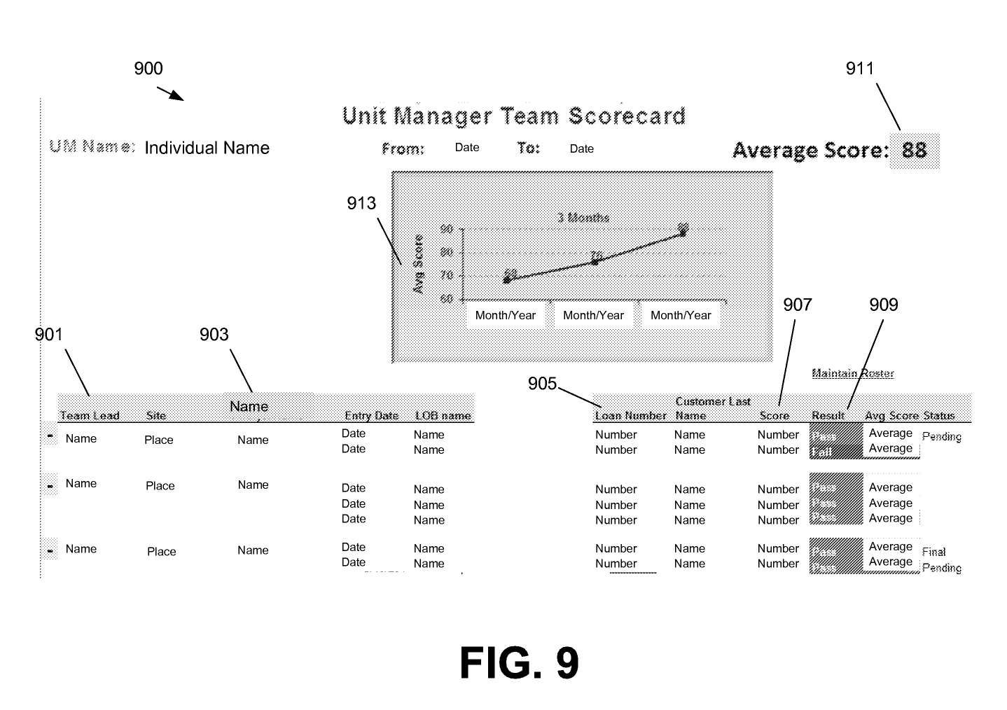

FIG. 9 illustrates an example manager scorecard user interface 900 for a manager to see her performance with respect to the performance of individual team members. In this example, a manager may have an average score 911 shown for all processing of loan applications by employees that the manager oversees. The manager may look to team lead column 901 and/or name column 903 to see about individual employees. Still further, loan number column 905 identifies various loan applications included in the scorecard as well as the corresponding loan processing scores in score column 907 and results, whether pass or fail, in results column 909. A graphic 913 may be included in order for the manager to see about progress of the team over a period of time. Such a graphic 913 may be configured to change upon accessing of a specific employee or a specific team leader by the manager.

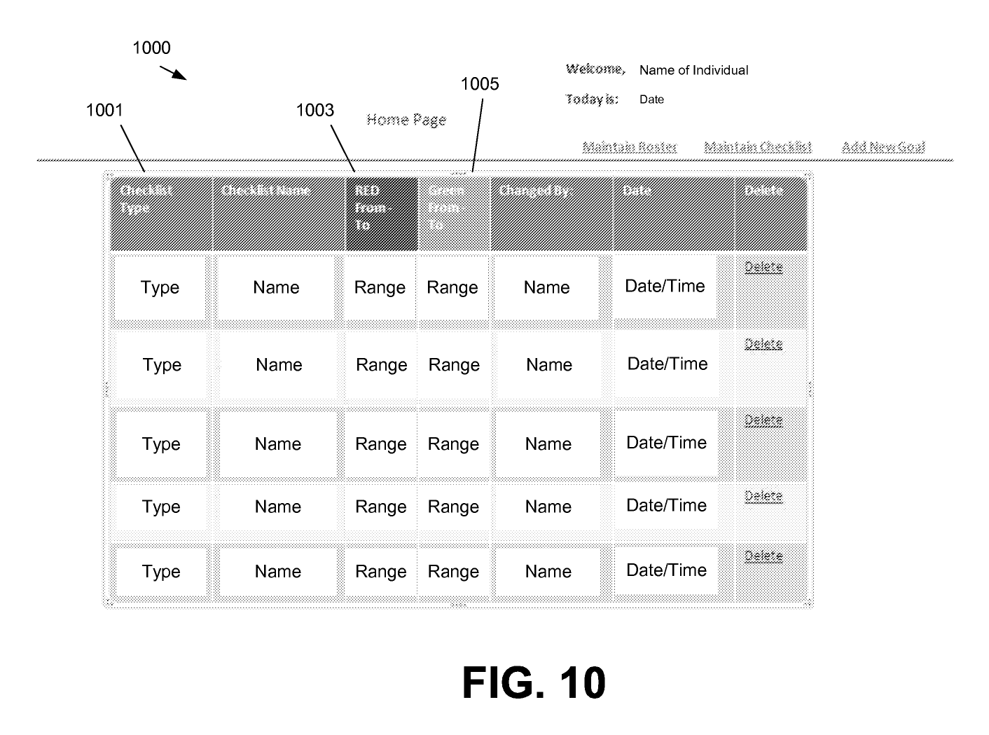

FIG. 10 illustrates an illustrative user interface 1000 that allows a manager, auditor, and/or system administrator to change one or more fields of the operation of the quality assurance system. In this example, an auditor may be accessing user interface 1000 in order to change various parameters for scoring the processing of a loan application by an employee. For example, for any particular item 1001 in a checklist for processing a loan application, an auditor may set a range and/or value 1003 that designates that a score in this range is an automatic failure for the processing of that loan application. Similarly, the auditor may set a range and/or value 1005 that designates that a score in this range is an automatic acceptance for the processing of that loan application. Any of a number of different items for processing of a loan application may be modified, added, and/or deleted through such a user interface 1000.

The above-described systems may be used in various businesses or corporate entities, such as financial institutions or other entities, to aid in managing one or more projects, tasks associated with projects, and the like. The systems may be part of or associated with an entity, such as the entity implementing the system. The entity may be a business, corporation, university or other educational institution, government agency, and the like. In some examples, the entity may be a financial institution, such as a bank. However, nothing in the specification or figures should be viewed as limiting any of the features or aspects described herein to only banks or banking related issues. In some examples, the system may be external to or separate from the entity (e.g., provided by or associated with a 3^{rd} party or outside vendor).

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present disclosure.

What is claimed is:

1. An apparatus comprising:
at least one processor; and
memory operatively coupled to the at least one processor and storing computer readable instructions that, when executed, cause the apparatus to:
receive data representative of a loan application processed by an employee, the data including records of information obtained by the employee and processes performed by the employee in determining whether to authorize a loan for the loan application;
receive data representative of a first auditor determined loan processing score below an acceptable score the employee received associated with determining whether to authorize the loan for the loan application, the data representative of the first auditor determined loan processing score based upon the received data representative of the loan application processed by the employee;
receive a request initiated from the employee requesting reevaluation of the loan processing score below the acceptable score;
automatically generate a first notice to the manager, the first notice representative of the received request from the employee;
receive a response to the generated first notice, the response representative of a determination by a manager of the employee to have a second auditor reevaluate the loan processing score; and
automatically generate a second notice to the second auditor, the second notice to the second auditor representative of the received response from the manager to have the second auditor reevaluate the loan processing score.

2. The apparatus of claim 1, the memory storing computer readable instructions that, when executed, further cause the apparatus to automatically generate a third notice to the employee including the loan processing score below the acceptable score and at least one reason the employee received the loan processing score.

3. The apparatus of claim 1, the memory storing computer readable instructions that, when executed, further cause the apparatus to automatically generate a third notice to the manager of the employee including the loan processing score below the acceptable score and at least one reason the employee received the loan processing score.

4. The apparatus of claim 1, the memory storing computer readable instructions that, when executed, further cause the apparatus to receive data representative that the reevaluation of the loan processing score by the second auditor is complete.

5. The apparatus of claim 1, the memory storing computer readable instructions that, when executed, further cause the apparatus to:
determine whether a time period has lapsed between generation of the second notice to the second auditor and receipt of a response from the second auditor; and
upon determining that the time period has not lapsed, receive data representative that the reevaluation of the loan processing score by the second auditor is complete.

6. The apparatus of claim 1, the memory storing computer readable instructions that, when executed, further cause the apparatus to automatically generate a third notice to the employee and the manager, the third notice representative of a reevaluated loan processing score for the employee.

7. The apparatus of claim 1, the memory storing computer readable instructions that, when executed, further cause the apparatus to:
determine whether a time period has lapsed between generation of the second notice to the second auditor and receipt of a response from the second auditor; and
upon determining that the time period has lapsed, automatically generate a third notice to the employee and the manager, the third notice representative that the loan processing score will not be reevaluated by the second auditor.

8. The apparatus of claim 1, wherein the first auditor and the second auditor are the same auditor.

9. The apparatus of claim 1, wherein the first and second notices are emails.

10. A method comprising:
receiving, at a computing device, data representative of a loan application processed by an employee, the data including records of information obtained by the employee and processes performed by the employee in determining whether to authorize a loan for the loan application;
receiving, at the computing device, data representative of a first auditor determined loan processing score below an acceptable score the employee received associated with determining whether to authorize the loan for the loan application, the data representative of the first auditor determined loan processing score based upon the received data representative of the loan application processed by the employee;
receiving, at the computing device, a request initiated from the employee requesting reevaluation of the loan processing score below the acceptable score;
automatically generating, at the computing device, a first notice to the manager, the first notice representative of the received request from the employee;
receiving, at the computing device, a response to the generated first notice, the response representative of a determination by a manager of the employee to have a second auditor reevaluate the loan processing score; and
automatically generating, at the computing device, a second notice to the second auditor, the second notice to the second auditor representative of the received response from the manager to have the second auditor reevaluate the loan processing score.

11. The method of claim 10, further comprising automatically generating a third notice to the employee including the loan processing score below the acceptable score and at least one reason the employee received the loan processing score.

12. The method of claim 10, further comprising automatically generating a third notice to the manager of the employee including the loan processing score below the acceptable score and at least one reason the employee received the loan processing score.

13. The method of claim 10, further comprising receiving data representative that the reevaluation of the loan processing score by the second auditor is complete.

14. The method of claim 10, further comprising:
determining whether a time period has lapsed between generation of the second notice to the second auditor and receipt of a response from the second auditor; and
upon determining that the time period has not lapsed, receiving data representative that the reevaluation of the loan processing score by the second auditor is complete.

15. The method of claim 10, further comprising automatically generating a third notice to the employee and the manager, the third notice representative of a reevaluated loan processing score for the employee.

16. The method of claim 10, further comprising:
determining whether a time period has lapsed between generation of the second notice to the second auditor and receipt of a response from the second auditor; and
upon determining that the time period has lapsed, automatically generating a third notice to the employee and the manager, the third notice representative that the loan processing score will not be reevaluated by the second auditor.

17. A non-transitory computer readable medium storing computer readable instructions that, when executed, cause an apparatus to perform a method comprising:
receiving data representative of a loan application processed by an employee, the data including records of information obtained by the employee and processes performed by the employee in determining whether to authorize a loan for the loan application;
receiving data representative of a first auditor determined loan processing score below an acceptable score the employee received associated with determining whether to authorize the loan for the loan application, the data representative of the first auditor determined loan processing score based upon the received data representative of the loan application processed by the employee;
receiving a request initiated from the employee requesting reevaluation of the loan processing score below the acceptable score;
automatically generating a first notice to the manager, the first notice representative of the received request from the employee;
receiving a response to the generated first notice, the response representative of a determination by a manager of the employee to have a second auditor reevaluate the loan processing score; and
automatically generating a second notice to the second auditor, the second notice to the second auditor representative of the received response from the manager to have the second auditor reevaluate the loan processing score.

18. The non-transitory computer readable medium of claim 17, the computer readable instructions that, when executed, further cause an apparatus to perform a method comprising automatically generating a third notice to the employee including the loan processing score below the acceptable score and at least one reason the employee received the loan processing score and automatically generating a fourth notice to the manager of the employee including the loan processing score below the acceptable score and at least one reason the employee received the loan processing score.

19. The non-transitory computer readable medium of claim 17, the computer readable instructions that, when executed, further cause an apparatus to perform a method comprising:
determining whether a time period has lapsed between generation of the second notice to the second auditor and receipt of a response from the second auditor; and
upon determining that the time period has not lapsed, receiving data representative that the reevaluation of the loan processing score by the second auditor is complete.

20. The non-transitory computer readable medium of claim 17, the computer readable instructions that, when executed, further cause an apparatus to perform a method comprising:
determining whether a time period has lapsed between generation of the second notice to the second auditor and receipt of a response from the second auditor; and
upon determining that the time period has lapsed, automatically generating a third notice to the employee and the manager, the third notice representative that the loan processing score will not be reevaluated by the second auditor.
